(19) United States
(12) Patent Application Publication
(10) Pub. No.: US 2022/0393799 A1
(43) Pub. Date: Dec. 8, 2022

(54) APPARATUS AND METHOD FOR PROCESSING HYBRID AUTOMATIC REPEAT REQUEST (HARQ) FEEDBACK

(71) Applicant: JRD COMMUNICATION (SHENZHEN) LTD., Shenzhen, Guangdong (CN)

(72) Inventors: Tian Li, Shenzhen, Guangdong (CN); Jia Sheng, Shenzhen, Guangdong (CN)

(73) Assignee: JRD COMMUNICATION (SHENZHEN) LTD., Shenzhen, Guangdong (CN)

(21) Appl. No.: 17/755,441

(22) PCT Filed: Nov. 8, 2019
(86) PCT No.: PCT/CN2019/116790

§ 371 Date: Apr. 29, 2022

(51) Int. Cl. H04L 1/18; H04W 74/08; H04L 1/16

(52) U.S. Cl. CPC H04L 1/1812; H04W 74/0808; H04L 1/1685

(57) ABSTRACT

A method for processing hybrid automatic repeat request (HARQ) feedback is disclosed. A base station, such as a gNB, triggers one-shot HARQ acknowledgement (ACK) feedback in response to the detected triggering condition. The base station obtains multiple versions of HARQ ACK bits for a transport unit from the one-shot HARQ ACK feedback, and consolidates the versions of HARQ ACK bits for the transport unit when a subsequently transmitted version among the versions of the HARQ ACK bits is inconsistent with a previous version among the versions of the HARQ ACK bits.

### BACKGROUND OF DISCLOSURE

### 1. Field of Disclosure

The present disclosure relates to the field of communication systems, and more particularly, to an apparatus and a method for processing hybrid automatic repeat request (HARQ) feedback.

### 2. Description of Related Art

When hybrid automatic repeat request (HARQ)-acknowledgement (ACK) feedback is transmitted over an unlicensed band, reliable and efficient HARQ-ACK feedback transmission becomes more critical in standalone mode, which is not backed by licensed carrier.

### Technical Problem

One of the main problems of sending downlink (DL) HARQ-ACK is the unpredictability of uplink (UL) transmission opportunity in time due to listen-before-talk (LBT) mechanism To overcome this unpredictability and ensure feedback is safely received, it is essential to enhance the HARQ-ACK codebook and transmission schemes.

It is desired to further define the requirement for triggering the one-shot HARQ ACK feedback and processing of the HARQ-ACK bits for the same HARQ process.

### SUMMARY

An object of the present disclosure is to propose an apparatus and a method for processing hybrid automatic repeat request (HARQ) feedback.

In a first aspect of the present disclosure, a method for processing hybrid automatic repeat request (HARQ) feedback includes detecting a triggering condition in a radio access channel, and triggering one-shot HARQ ACK feedback in response to the detected triggering condition.

In a second aspect of the present disclosure, an apparatus for processing hybrid automatic repeat request (HARQ) feedback includes a transceiver configured to transceiving HARQ signalling and a processor configured to execute the steps of detecting a triggering condition in a radio access channel; and triggering one-shot HARQ acknowledgement (ACK) feedback in response to the detected triggering condition.

In a third aspect of the present disclosure, a method for processing hybrid automatic repeat request (HARQ) feedback includes triggering one-shot HARQ acknowledgement (ACK) feedback in response to the detected triggering condition; obtaining different versions of HARQ ACK bits for a transport unit from the one-shot HARQ ACK feedback; and consolidating the versions of HARQ ACK bits for the transport unit when a subsequently transmitted version among the versions of the HARQ ACK bits is inconsistent with a previous version among the versions of the HARQ ACK bits.

An apparatus for processing hybrid automatic repeat request (HARQ) feedback includes transceiver configured to transceiving HARQ signalling and a processor. The processor executes the steps of triggering one-shot HARQ acknowledgement (ACK) feedback in response to the detected triggering condition; obtaining different versions of HARQ ACK bits for a transport unit from the one-shot HARQ ACK feedback; and consolidating the versions of HARQ ACK bits for the transport unit when a subsequently transmitted version among the versions of the HARQ ACK bits is inconsistent with a previous version among the versions of the HARQ ACK bits.

The disclosed method may be programmed as computer executable instructions stored in non-transitory computer readable medium. The non-transitory computer readable medium, when loaded to a computer, directs a processor of the computer to executed the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### Advantageous Effects

The disclosure provides one-shot HARQ ACK feedback solutions. Three conditions are proposed to be triggering conditions for one-shot HARQ ACK feedback. One-shot HARQ ACK feedback is requested to solve more scheduling issues and reduces more signaling overhead. The disclosed method processes the HARQ-ACK bits of the same HARQ process could help gNB improve system performance.

### DESCRIPTION OF DRAWINGS

In order to more clearly illustrate the embodiments of the present disclosure or related art, the following FIG.s will be described in the embodiments are briefly introduced. It is obvious that the drawings are merely some embodiments of the present disclosure, a person having ordinary skill in this field can obtain other FIG.s according to these figures.

FIG. 1 is a block diagram of a user equipment (UE), a base station (BS), according to an embodiment of the present disclosure.

FIG. 2 is a schematic diagram of a method for processing hybrid automatic repeat request (HARQ) feedback according to an embodiment of the present disclosure.

FIG. 3 is a schematic diagram of a method for processing HARQ feedback using group identifier (ID) and counter downlink assignment indicator (C-DAI) as a triggering condition.

FIGS. 4 and 5 illustrate an example of a C-DAI reaching the maximum.

FIG. 6 a schematic diagram of a method for processing HARQ feedback using a misalignment event of HARQ bits as a triggering condition.

FIG. 7 illustrate HARQ ACK bits between a UE and a BS.

FIG. 8 is a schematic diagram of a method for processing HARQ feedback using a listen-before-talk (LBT) failure event as a triggering condition.

FIG. 9 illustrate an HARQ process and transport units between a UE and a BS on an unlicensed band where LBT failure occurs.

FIG. 10 is a schematic diagram of a method for processing HARQ feedback discarding previous version of HARQ ACK bits.

FIG. 11 illustrate an HARQ process and transport units between a UE and a BS with a misalignment event of HARQ bits.

FIG. 12 is a schematic diagram of a method for processing HARQ feedback requesting retransmission of one-shot HARQ ACK feedback according to an embodiment of the disclosure.

FIG. 13 illustrate an HARQ process and transport units between a UE and a BS with a misalignment event of HARQ bits.

FIG. 14 is a schematic diagram of a method for processing HARQ feedback requesting retransmission of one-shot HARQ ACK feedback according to another embodiment of the disclosure.

FIG. 15 illustrate an HARQ process and transport units between a UE and a BS with a misalignment event of HARQ bits.

FIG. 16 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The invention is related to the wireless communication systems operating in unlicensed bands. More specifically, an objective of the disclosure is to facilitate better use of HARQ in the New Radio based unlicensed (NR-U) spectrum. An objective of the disclosure is to provide a one-shot hybrid automatic repeat request (HARQ) acknowledgement (ACK) feedback method, which works as a fallback solution for semi-static and dynamic HARQ-ACK feedback mechanism. As a simple and effective way, one-shot HARQ ACK feedback is used to indicate the latest HARQ-ACK message. A user equipment (UE) should report all configured HARQ processes as soon as receiving triggering downlink control information (DCI). One-shot HARQ-ACK feedback is feedback of a HARQ-ACK codebook containing all downlink (DL) HARQ processes for all component carrier (CCs) configured for a UE in the physical uplink control channel (PUCCH) group.

In 3GPP RAN1 #97 meeting, RAN1 agreed to adopt group based HARQ-ACK retransmission for dynamic codebook. For group-based HARQ-ACK feedback, physical downlink shared channels (PDSCHs) scheduled to a UE would be grouped by a network. When the UE receives a downlink control information (DCI) scheduling a PDSCH belonging to a PDSCH group, all PDSCHs in the same PDSCH group are requested to be acknowledged in the same PUCCH indicated by the DCI.

In some scenarios, the network may need to initiate more than one PDSCH groups to allow flexible scheduling behavior, and up to two PDSCH groups should be sufficient.

Counter downlink assignment indicator/total downlink assignment indicator (C-DAI/T-DAI) is utilized to provide a UE with correct knowledge of the number of scheduled PDSCHs in a PDSCH group. C-DAI/T-DAI is always accumulated over all PDSCHs per PDSCH group. For every PDSCH transmission, the DAI value in the DCI is incremented. The DAI in the DL scheduling DCI should be stepped by one as compared to the immediately preceding DL scheduling DCI. Difference between the two received DAI values at the UE in current and earlier DCI greater than 1 is an indication that PDCCH transmission(s) has been missed. Moreover, misdetection of the last DCI(s) scheduled PDSCH(s) in a PDSCH group can lead to misalignment of codebook size when the HARQ-ACK codebook from the PDSCH group are concatenated with a HARQ-ACK codebook from other PDSCH group in the same PUCCH. The misalignment between the gNB's expected codebook size and the reported codebook size by the UE is very likely to happen on an unlicensed band due to LBT failure for PUCCH/PUSCH transmission, or PUCCH/PUSCH detection failure at gNB.

In the RAN1#96bis meeting, one-shot HARQ-ACK feedback was discussed as a fallback solution for semi-static and dynamic HARQ-ACK codebook determination in order to address the error cases caused by LBT failure or miss-detection. One-shot group HARQ-ACK feedback triggering would be a simple and robust way, where gNB could send a trigger to indicate to the UE to report the HARQ-ACK feedback for all configured HARQ processes.

The agreed dynamic HARQ-ACK codebook can also support HARQ-ACK transmission for all PDSCHs by indicating multiple groups in a DCI. It has the benefit of smaller codebook size, however, some misalignment or ambiguity about HARQ-ACK bits between gNB and UE may occur when HARQ-ACK feedbacks for more than one group are requested. In other words, the dynamic HARQ-ACK feedback is applicable to most favorite scenarios, while one-shot HARQ-ACK feedback mechanism is beneficial in worst cases.

Once receiving a DCI that requests one-shot feedback, the HARQ-ACK bits for all the configured downlink HARQ processes is transmitted by a UE. Thus, not only the previously transmitted HARQ-ACK feedback but also the pended/unreported/missed HARQ-ACK feedbacks can be triggered for transmission. As a result, the HARQ-ACK of a same HARQ process can be reported multiple times when the fallback mechanism of one-shot HARQ-ACK is triggered. Furthermore, the disclosure proposes that one-shot HARQ-ACK may be requested, if gNB detects misalignment of HARQ-ACK codebook. However, since one-shot HARQ-ACK feedback results in a relatively large HARQ-ACK codebook, detailed conditions for triggering the one-shot HARQ-ACK feedback need to further investigate.

The disclosure proposes several one-shot HARQ ACK solutions, including usage of repeated HARQ messages. As detailed requirements for triggering one-shot HARQ ACK feedback are currently not yet undefined, the disclosure also provides conditions for triggering one-shot HARQ ACK feedback to address scheduling issues and reduce HARQ signaling overhead. Based the proposed specific triggering conditions, a base station, such a gNB, may trigger the one-shot HARQ-ACK feedback effectively, and improve system performance.

Additionally, since HARQ bits for one specific HARQ process may be reported more than one times, a base station decides how to process the repeatedly reported HARQ bits. The disclosure provides HARQ processing methods specifying gNB's behavior on the HARQ-ACK to take advantage of the repeated HARQ bits. HARQ-ACK bits for one specific PDSCH transport unit, such as a transport block (TB), a code block group (CBG), and a code block (CB), may be transmitted multiple times when the one-shot HARQ ACK feedback is requested. As usage of repeatedly reported HARQ information is not yet specified, embodiments of the disclosed methods are proposed for a base station to process repeatedly reported HARQ-ACK bits.

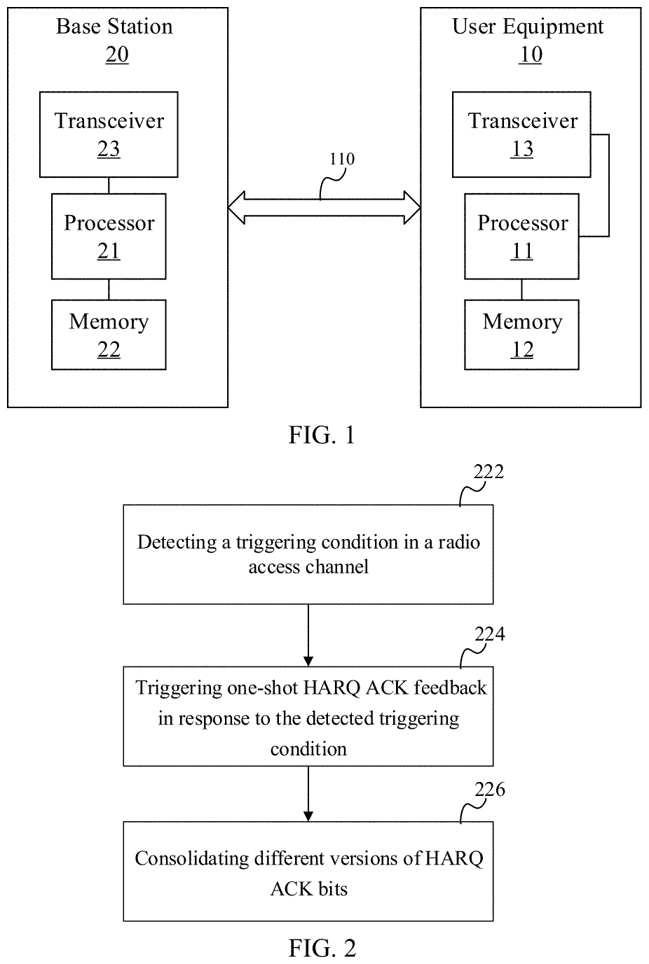

FIG. 1 illustrates that, in some embodiments, a user equipment (UE) 10 and a base station (BS) 20 for processing hybrid automatic repeat request (HARQ) feedback according to an embodiment of the present disclosure are provided. The UE 10 may include a processor 11, a memory 12, and a transceiver 13. The base station 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry and radio frequency (RF) circuitry to process radio frequency signals. When the embodiments of the invention are implemented in software, the techniques described herein can be implemented with modules, such as procedures, functions, and executable programs, that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via an interface.

In some embodiments, the processor 21 is configured to execute a method for processing HARQ feedback. The method includes detecting a triggering condition in a radio access channel, and triggering one-shot HARQ ACK feedback in response to the detected triggering condition.

In some embodiments, the HARQ process is a dynamic HARQ ACK feedback process. The disclosed method includes determining an overflow event as the triggering condition. The overflow event indicates that a number of groups of transport units are transmitted, the number of the groups of transport units reaches a maximum group identifier (ID) associated with the dynamic HARQ ACK feedback process, and a counter downlink assignment indicator (C-DAI) of the groups of transport units is incremented to a maximum C-DAI associated with the dynamic HARQ ACK feedback process.

In some embodiments, each of the transport units may be a code block.

In some embodiments, the triggering condition is met when listen before talk (LBT) failure is detected. The disclosed method includes determining an LBT failure event as the triggering condition, wherein the LBT failure event indicates that LBT failure is detected.

In some embodiments, the triggering condition is met when HARQ ACK bits received by a base station is different from HARQ ACK bits sent by a user equipment (UE). The disclosed method further includes determining a misalignment event as the triggering condition. The misalignment event indicates that HARQ ACK bits received by a base station is different from HARQ ACK bits sent by a UE. For example, the misalignment event may indicate that a HARQ ACK codebook size expected to be sent to a gNB is different from a HARQ ACK codebook size actually reported by a UE. The disclosed method may include determining an event of two misalignment onsets in a predetermined duration as the triggering condition.

In some embodiments, the triggering condition is met when multiple versions of HARQ ACK bits for a transport unit are received, and a subsequently transmitted version among the versions of the HARQ ACK bits is inconsistent with a previous version among the versions of the HARQ ACK bits. The disclosed method further includes determining a confliction event as the triggering condition. The confliction event indicates that multiple versions of HARQ ACK bits for a transport unit are received, and a subsequently transmitted version among the versions of the HARQ ACK bits is inconsistent with a previous version among the versions of the HARQ ACK bits.

In some embodiments, the disclose method further includes receiving an updated version from the one-shot HARQ ACK feedback as the last version among the versions of the HARQ ACK bits, discarding the previous version, and using the last version as a basis for data retransmission.

In some embodiments, the disclose method further includes requesting retransmission of the one-shot HARQ ACK feedback when the last version is inconsistent with the versions of the HARQ ACK bits.

In some embodiments, the disclose method further includes requesting retransmission of the one-shot HARQ ACK feedback when a proportion of bits in the last version is inconsistent with the versions of the HARQ ACK bits, and the proportion is greater than a threshold.

In some embodiments, the disclosed method may be implemented in a Third Generation Partnership Project (3GPP) compliant BS and a UE.

Aspects for realizing one-shot HARQ-ACK feedback are provided in the following. A transport unit transmitted between a transmitter, such as one of a UE and a BS, and a receiver, such as the other one of a UE and a BS, may include one of a transport block (TB), a code block group (CBG), and a code block (CB). With reference to FIG. 2, the BS 20 detects a triggering condition in a HARQ process (block 222). Detailed conditions for triggering one-shot HARQ ACK feedback are further investigated. In the disclosure, several conditions for triggering one-shot HARQ ACK feedback are proposed to make full use of the one-shot HARQ ACK feedback mechanism. One-shot HARQ-ACK feedback may serve as a fallback solution for semi-static and dynamic HARQ-ACK during HARQ codebook processing when the conditions for triggering this one-shot HARQ mechanism are met.

The BS 20 triggers one-shot HARQ ACK feedback in response to the detected triggering condition (block 224). The BS 20 may trigger one-shot HARQ ACK feedback by sending downlink control information (DCI) to the UE 10, and the UE 10 sends one-shot HARQ ACK feedback to the BS 20 in response to the DCI. The BS 20 receives HARQ ACK bits in the one-shot HARQ ACK feedback. One-shot HARQ-ACK feedback may generate an additional version of a HARQ bit for a same transport unit for which a previous version of a HARQ bit has been reported to BS 20 before the fallback, that is, before the triggering of the one-shot HARQ. Accordingly, the HARQ bit for one specific HARQ process may be reported more than one time when one-shot HARQ-ACK feedback is triggered. The BS 20 consolidates different versions of HARQ ACK bits (block 226). According to the disclosed method, a base station, such as a gNB, decides how to process the repeatedly reported HARQ information.

One-shot HARQ-ACK feedback may act as a fallback solution for semi-static and dynamic HARQ-ACK during HARQ codebook processing to address the special issues, such as HARQ misalignment between a UE and a base station, and ambiguity on HARQ-ACK bits. Detailed conditions for triggering one-shot HARQ ACK feedback have not been specified currently, and hence how the gNB can effectively operate with this mechanism is not clear. More situations for triggering one-shot HARQ ACK feedback may be identified in order to transmit the HARQ-ACK bits effectively, of which some are listed in the following:

A condition for triggering one-shot HARQ ACK feedback may be when counter downlink assignment indicator/total downlink assignment indicator (C-DAI/T-DAI) reaches the maximum value.

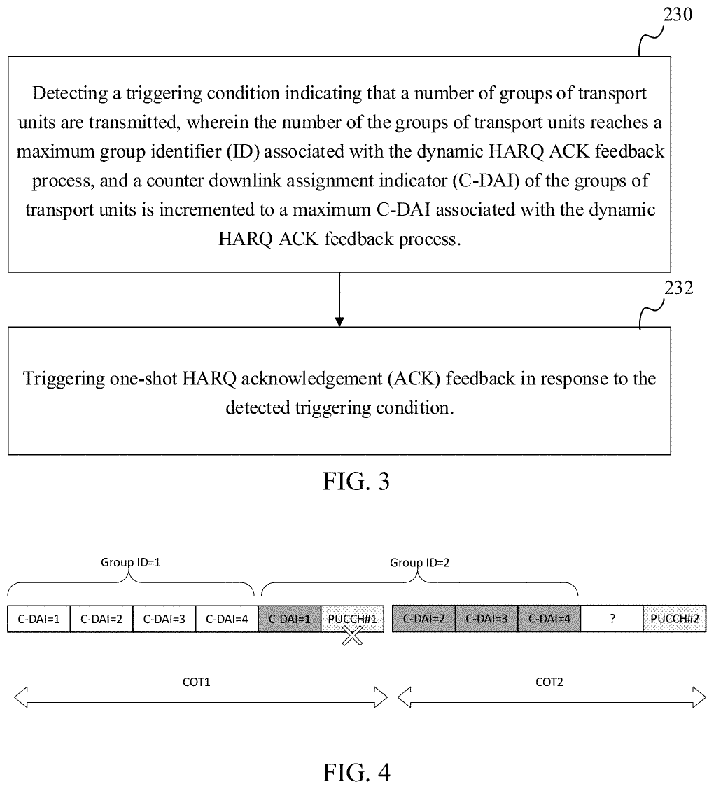

With reference to FIG. 3, the BS 20 transmits a number of groups of transport units to the UE 10 in a dynamic HARQ ACK feedback process, and the UE 10 receives the transmitted groups of the transport units. The BS 20 detects a triggering condition indicating that number of the groups of transport units reaches a maximum group ID associated with the dynamic HARQ ACK feedback process, and a C-DAI of the groups of transport units is incremented to a maximum C-DAI associated with the dynamic HARQ ACK feedback process (block 230). The BS 20 triggers one-shot HARQ ACK feedback in response to the detected triggering condition (block 232).

Whether to configure the enhanced dynamic codebook and whether to trigger one-shot feedback may be determined using signaling between a UE and a base station. In an embodiment, the maximum C-DAI is 4, and the maximum group ID is 2. The C-DAI/T-DAI may easily reach the maximum when the BS 20 detects the PUCCH transmission failure. Though the maximum is extendable, using more DCI bits for indicating the C-DAI/T-DAI may substantially increase overhead.

As shown in FIG. 4, the PDSCH transport units with C-DAI 1-4 in the first channel occupancy time (COT) are scheduled as first group with group ID being 1 while corresponding HARQ-ACK feedback of the first group fails in the first PUCCH transport unit, shown as PUCCH#1. Furthermore, the fifth PDSCH transport unit with C-DAI 1 in the first COT and PDSCH transport units with C-DAI 2-4 in the second COT are scheduled as a second group with group ID being 2. The BS 20 may detect the failure of the first PUCCH transport unit when scheduling the PDSCH transport unit with C-DAI 2 in the second COT. Meanwhile, the UE 10 reports HARQ-ACK feedback for both of the two groups in the same PUCCH transport unit, such as the second PUCCH, to the BS 20. Since the group ID and C-DAI/T-DAI are occupied by-previously scheduled PDSCH, the fourth PDSCH transport unit of the second COT cannot be scheduled by BS 20. As a result, the BS 20 may suffer from the scheduling restriction and affect system performance.

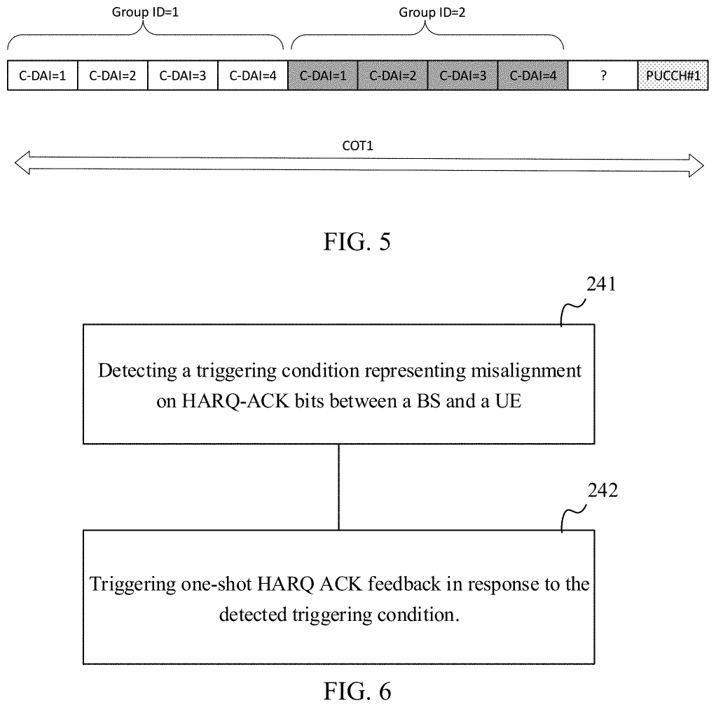

Note that reconfiguring the maximum C-DAI may not solve the problem. One-shot HARQ-ACK feedback is proposed in the triggering condition to send HARQ-ACK bits corresponding to the PDSCH transport units for all HARQ processes configured for the UE. The disclosed method may be applied to an example as shown in FIG. 5. With reference to FIG. 5, the BS 20 triggers one-shot HARQ ACK feedback when the number of the groups of transport units reaches a maximum group ID associated with the dynamic HARQ ACK feedback process, and a C-DAI of the groups of transport units is incremented to a maximum C-DAI associated with the dynamic HARQ ACK feedback process.

Another condition for triggering one-shot HARQ ACK feedback may be an HARQ misalignment event.

In the following, inconsistency between HARQ-ACK bits transmitted by a UE and HARQ-ACK bits received by a base station is referred to as misalignment. The UE 10 calculates a HARQ ACK codebook size according to the PDDCH information. Hence, decoding of PDCCH is essential to HARQ codebook size determination. Missing PDCCH transmission is less likely on a licensed band, but is more frequent on an unlicensed band. With reference to FIG. 6, in the disclosed method, the BS 20 detects a triggering condition representing misalignment on HARQ-ACK bits between BS 20 and UE (block 241), and triggers one-shot HARQ-ACK feedback in response to the detected triggering condition (block 242).

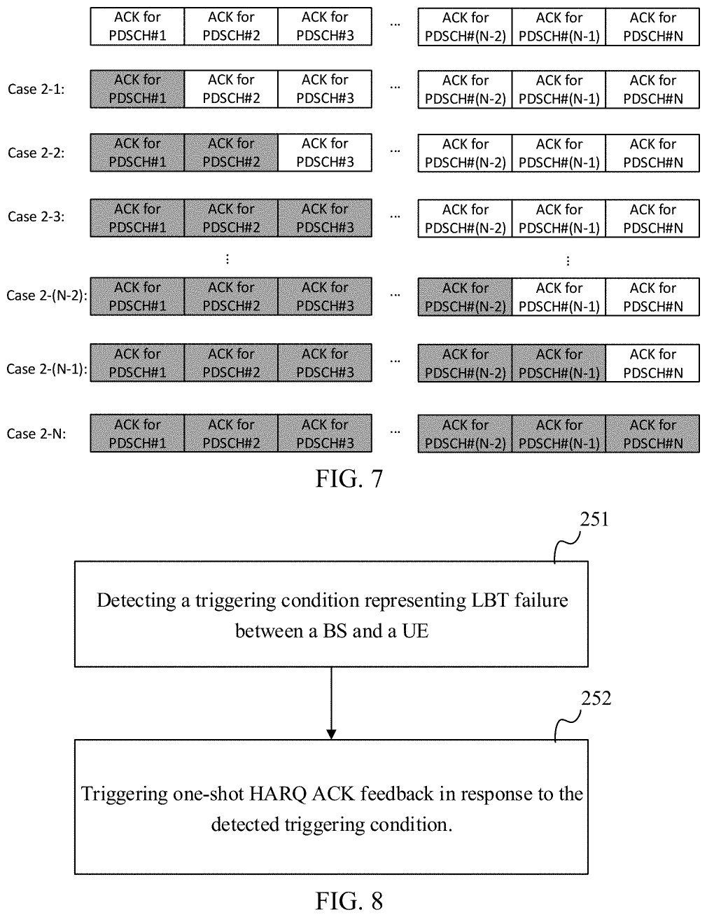

It is worth noting that the BS 20 missing one or more ACK bits for the scheduled PDSCH transport units would lead to misalignment or ambiguity. As shown in FIG. 7, the number of missing PUCCH ACKs in Case 2-i is i, where i is not greater than N, and N is the number of PDSCH transport units scheduled by the BS 20. A number of i-combination of a set of N elements representing i missing PUCCH ACKs in the N PDSCH transport units is C_{N}ⁱ in the case 2-i, where C is a mathematical combinational notation.

The total number of all the possible cases which may miss PUCCH ACK transmission in N PDSCH transport units can be calculated as:

Number_{missPUCCHACK}=(C_{N}⁰+C_{N}¹+C_{N}²+ . . . +C_{N}^{N-1}+C_{N}^{N})−1=2^{N}−1

Then, the probability of missing PUCCH ACK transmission can be described as:

$$P r o b a b i l i t {y}_{missPUCCHACK} = 1 - \frac{1}{{2}^{N} - 1}$$

According to the above formula (2), the probability of misalignment or ambiguity would be higher if BS 20 schedules reporting of HARQ-ACK bits for more PDSCHs in the same PUCCH. As BS 20 schedule more PDSCHs at the same time, misdetections of last PDCCH even deteriorates the probability of misalignment.

As a result, the BS 20 may request one-shot HARQ-ACK feedback frequently as soon as detecting misalignment of HARQ-ACK codebook. However, since one-shot feedback is requested to report HARQ-ACK information for all configured HARQ processes, one-shot HARQ-ACK feedback results in relatively large codebook size and signaling overhead. From the above analysis, in the disclosed method, the BS 20 may trigger one-shot HARQ-ACK feedback when misalignment of HARQ-ACK bits between BS 20 and UE occurs more than one time in a certain duration. That is, the BS 20 determines an event of two misalignment onsets in a predetermined duration as the triggering condition.

Another condition for triggering one-shot HARQ ACK feedback may be listen before talk (LBT) failure.

HARQ-ACK feedback may be carried out in unlicensed band, the uncertain availability of the unlicensed medium results in some special issues, such as LBT failure, PDCCH misdetections, and HARQ-ACK misdetections.

Thus, HARQ enhancement is required in an unlicensed band. For example, one-shot HARQ ACK feedback may be provided as a fallback mechanism for semi-static and dynamic HARQ-ACK mechanisms in an unlicensed band. One-shot HARQ-ACK feedback is used to indicate the latest HARQ-ACK status for all configured HARQ processes. A UE reports one-shot HARQ-ACK feedback as soon as receiving triggering DCI. With reference to FIG. 8, in the disclosed method, the BS 20 detects a triggering condition representing LBT failure between BS 20 and UE (block 251), and triggers one-shot HARQ-ACK feedback in response to the detected triggering condition (block 252).

When HARQ-ACK results are reported on the unlicensed band, HARQ-ACK feedback may be delayed unpredictably due to LBT failure. LBT failure may be caused by hidden node problems or bursty interference. The UE may perform category 2 or category 4 LBT procedures to access the channel to support PUCCH transmission.

For enhanced dynamic codebook operation, a non-numerical PDSCH-to-HARQ-timing-indicator is used to indicate the UE that the HARQ-ACK feedback for the corresponding PDSCH is postponed and may be reported in the next COT. According to the non-numerical PDSCH-to-HARQ-timing-indicator, not only the HARQ-ACK bits for the PDSCH in the current COT but also the HARQ-ACK bits for the PDSCH in the earlier COT can be transmitted in the current PUCCH.

For the semi-static codebook operation, the HARQ-ACK bits for the PDSCH in the current COT can be transmitted in the current PUCCH. If LBT fails in the current COT, the UE 10 cannot access the channel and HARQ-ACK feedback may be delayed. Since the one-shot HARQ-ACK feedback works as a fallback mechanism of semi-static and dynamic HARQ-ACK feedback mechanism, the BS 20 can trigger one-shot HARQ-ACK feedback to solve this severe issue upon LBT failure.

As shown in FIG. 9, the UE 10 is indicated that HARQ-ACK feedback for the PDSCH transmission 1 in the first COT is postponed, and the HARQ-ACK bits for the PDSCH transmission 1-3 in the second COT would be transmitted in the second PUCCH. However, LBT failure occurs in the second COT and then the HARQ-ACK bits are postponed until the next available PUCCH transmission. In the disclosed method, the BS 20 may trigger one-shot HARQ-ACK feedback to request UE report the corresponding HARQ-ACK bits upon LBT failure.

Usage of repeatedly reported HARQ information is provided in the following.

As a more effective and simpler mechanism, one-shot HARQ feedback works well as a fallback mechanism for semi-static and dynamic HARQ-ACK feedback. The BS 20 may request one-shot HARQ-ACK feedback for multiple times, which provides additional HARQ feedback transmission opportunities, and generates repeated copies of HARQ bits for the same HARQ process. HARQ bits for one HARQ process may be redundantly reported, and the BS 20 decides how to process the repeatedly reported HARQ bits. Embodiments of a base station using the repeatedly reported HARQ information is provided in the following.

An embodiment of the disclosed method includes discarding the HARQ bits.

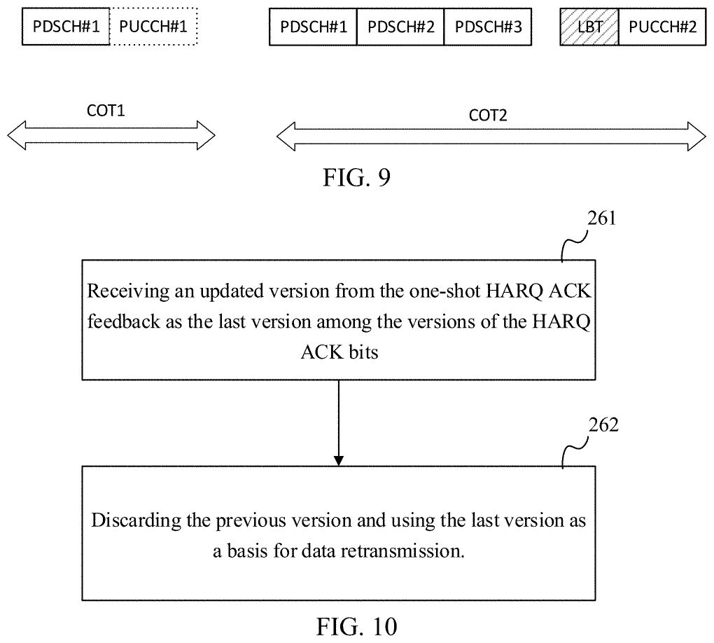

When one-shot HARQ-ACK feedback is triggered to include HARQ-ACK bits corresponding to the PDSCHs for all configured HARQ processes, additional HARQ feedback transmission opportunities are also provided. In the block 226 of FIG. 2, the BS 20 may discard the previously reported HARQ-ACK information and override the HARQ-ACK bits by the recently reported information. With reference to FIG. 10, the BS 20 receives an updated version from the one-shot HARQ ACK feedback as the last version among the versions of the HARQ ACK bits (block 261), discards the previous version, and using the last version as a basis for data retransmission in the HARQ process (block 262).

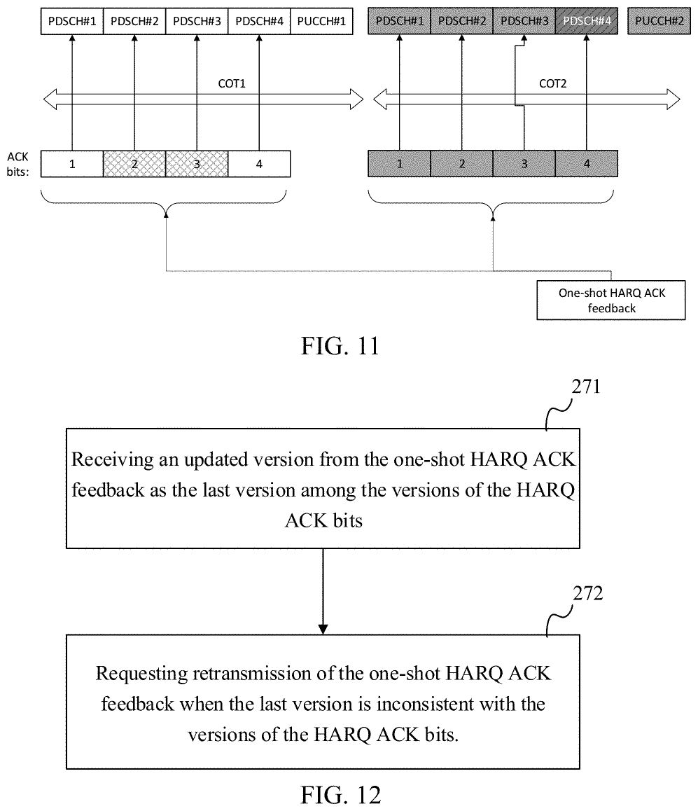

As shown in FIG. 11, BS 20 requests one-shot HARQ-ACK feedback when BS 20 detects misalignment because of missing the 4th PDCCH transmission in the second COT. Upon receiving a triggering DCI, the UE 10 transmits the latest HARQ-ACK status for all configured HARQ processes including the HARQ-ACK bits in the first COT and the second COT. Specifically, not only the HARQ-ACK bits for PDSCH 1-4 transmitted in the first COT but also the HARQ-ACK bits for PDSCH 1-4 transmitted in the second COT can be triggered for transmission. As a result, all the HARQ-ACK bits are reported twice except for the 4th HARQ-ACK status in the second COT. In the disclosed method, the BS 20 may process the redundant HARQ-ACK bits by discarding the previous HARQ-ACK bits and overriding the corresponding HARQ-ACK results by the recently reported HARQ-ACK bits.

An embodiment of the disclosed method includes triggering the retransmission of one-shot feedback when a last version of HARQ-ACK result mismatches a previous version of the HARQ-ACK result.

For unlicensed band, burst interference may occur for multiple PDSCHs unpredictably due to the unexpected interference from hidden nodes compared to the licensed band, which may cause occasional HARQ feedback detection failures. In other words, the same bit for a specific PDSCH transmitted from UE can be decoded as different values in different PUCCH transmissions. Without the disclosed method, the BS 20 may be confused by the different HARQ-ACK codebook and may not adopt the feedback results of one-shot HARQ-ACK mechanism. To use the repeatedly reported HARQ-ACK bits, the BS 20 may request retransmission of one-shot HARQ-ACK feedback if the latest HARQ-ACK codebook is different from the previous one.

With reference to FIG. 12, the BS 20 receives an updated version of ACK bits from the one-shot HARQ ACK feedback as the last version among the versions of the HARQ ACK bits (block 271), and requests retransmission of the one-shot HARQ ACK feedback when the last version is inconsistent with one of the versions the ACK bits (block 272).

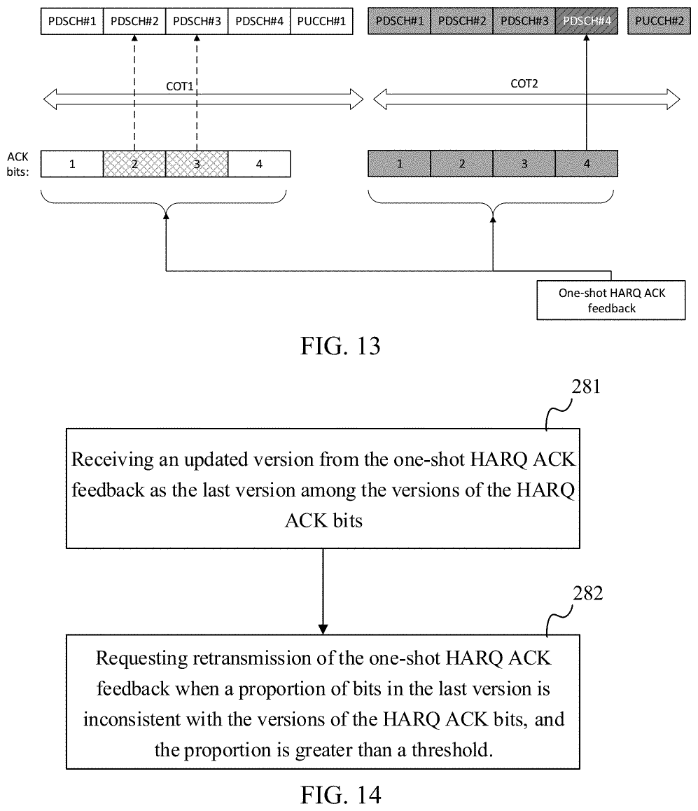

As shown in FIG. 13, the HARQ-ACK results corresponding to the PDSCH transmission 1-4 have been reported in the PUCCH transmission in the first COT by the UE 10 to the BS 20 for decoding. However, the BS 20 detects confliction between the BS 20 and the UE 10 due to misdetection of 4th PDCCH transmission in the second COT. The BS 20 requests one-shot HARQ-ACK feedback for all the PDSCHs in the first COT and second COT. The HARQ-ACK bits for PDSCH transmission 2&3 decoded by the BS 20 corresponding to the transmission of the first COT and one-shot HARQ-ACK feedback are shown in the Table 1.

TABLE 1

| Versions of HARQ-ACK bits | PDSCH 2 | PDSCH 3 |
|---|---|---|
| Original HARQ bits in UE | ACK | NACK |
| Previously received HARQ bits | ACK | NACK |
| Newly received HARQ bits in one-shot | NACK | ACK |
| HARQ-ACK feedback | | |

The confliction event indicates that multiple versions of HARQ ACK bits for a transport unit are received, and a subsequently transmitted version among the versions of the HARQ ACK bits is inconsistent with a previous version among the versions of the HARQ ACK bits. In detail, the BS 20 decodes the HARQ-ACK results in the PUCCH transmission of the first COT for these two PDSCH transmission 2&3 while the newly received HARQ-ACK bits of one-shot HARQ-ACK feedback are inconsistent with to the original HARQ-ACK bits in the UE 10. That is to say, the PUCCH decoding result for a same HARQ process can be mismatch due to the severe sporadic interface problem in the unlicensed band for two transmissions. The BS 20 may adopt the recently received results or not based on comparison between a previous version and a last version of HARQ-ACK bits corresponding to a specific PDSCH transport unit. In the disclosed method, the BS 20 triggers retransmission of one-shot HARQ-ACK feedback when a version of a HARQ-ACK bit corresponding to a specific PDSCH is inconsistent with the previous one.

In an embodiment of the invention, whether the retransmission of one-shot feedback is triggered depends on the number of mismatch bits in the last version of the HARQ-ACK bits.

With reference to FIG. 14, the BS 20 receives an updated version from the one-shot HARQ ACK feedback as the last version among the versions of the HARQ ACK bits (block 281), requests retransmission of the one-shot HARQ ACK feedback when a proportion of bits in the last version is inconsistent with the versions of the HARQ ACK bits, and the proportion is greater than a threshold (block 282).

Similar to the embodiment of retransmitting one-shot HARQ-ACK feedback, the UE may report a part of the HARQ-ACK results to the BS 20. The BS 20 requests one-shot HARQ-ACK feedback due to inconsistency of HARQ-ACK codebook in the second COT. Regarding the repeatedly transmitted HARQ-ACK bits, only a minority of HARQ-ACK bits last received by the BS 20 have changed compared with the previous HARQ-ACK bits for the same PDSCH. Retransmitting a codebook of one-shot HARQ-ACK feedback may introduce the signaling overhead. In the disclosed method, the BS 20 may accept the newly transmitted HARQ-ACK results if only a small proportion of the last version of the HARQ-ACK bits lower than a threshold, such as 10%, are different from the former version of the HARQ-ACK bits. On the contrary, the BS 20 may trigger retransmission of one-shot HARQ-ACK feedback if a proportion of the last version of the HARQ-ACK bits greater than a threshold are different from the former version of the HARQ-ACK bits.

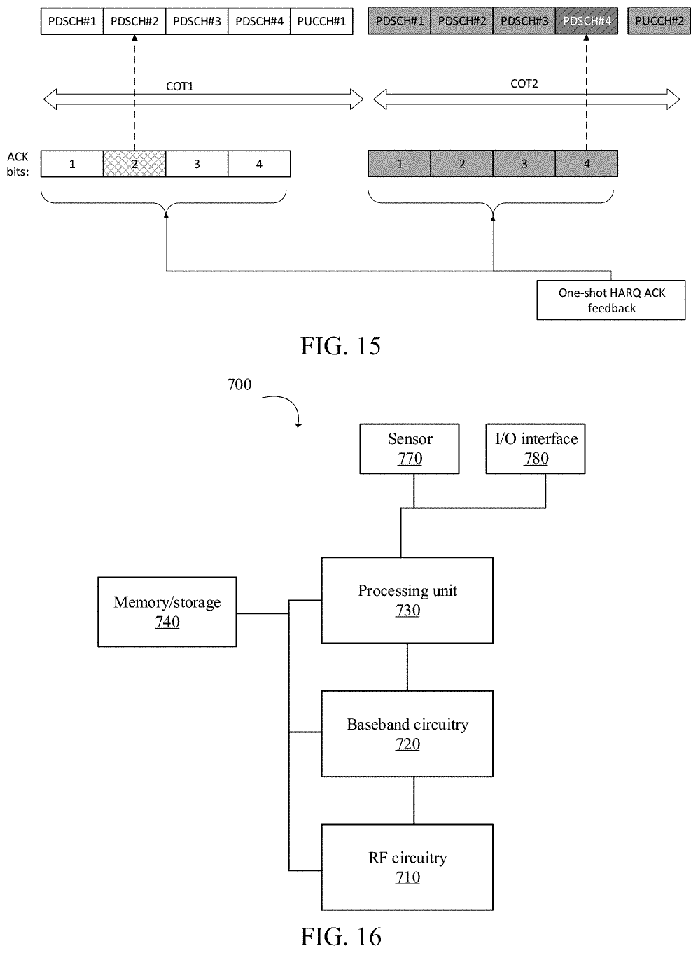

As shown in FIG. 15, only the HARQ-ACK bit for PDSCH transport unit 2 is inconsistent, and the inconsistent bit forms only a proportion of the last version of the HARQ-ACK bits lower than a threshold. The BS 20 accepts the HARQ-ACK results for all the PDSCHs which are transmitted in the one-shot HARQ-ACK feedback. In the disclosed method, the BS 20 adopts the recently reported HARQ-ACK bits for all the PDSCHs if only a small mismatch proportion of the HARQ-ACK bits is less than the threshold. The BS 20 triggers the retransmission of one-shot HARQ-ACK feedback directly if a mismatch proportion of the HARQ-ACK bits is greater than the threshold.

FIG. 16 is a block diagram of an example system 700 for wireless communication according to an embodiment of the present disclosure. Embodiments described herein may be implemented into the system using any suitably configured hardware and/or software. FIG. 16 illustrates the system 700 including a radio frequency (RF) circuitry 710, a baseband circuitry 720, an application circuitry 730, a memory/storage 740, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitries, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosure provides one-shot HARQ ACK feedback solutions. Three conditions are proposed to be triggering conditions for one-shot HARQ ACK feedback. Comparing to the current triggering conditions, such as HARQ ACK misalignment between the BS 20 and the UE 10, it is proposed to further define misalignment to reduce the signaling overhead. Since one-shot HARQ ACK feedback works as a fallback solution for semi-static and dynamic HARQ-ACK feedback, two solutions are proposed to address the severe and typical issues which exist in the semi-static or dynamic HARQ-ACK feedback. Accordingly, one-shot HARQ ACK feedback is requested to solve more scheduling issues and reduces more signaling overhead. The disclosed method processes the HARQ-ACK bits of the same HARQ process could help gNB improve system performance.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for processing hybrid automatic repeat request (HARQ) feedback, comprising:
detecting a triggering condition in a radio access channel; and
triggering one-shot HARQ acknowledgement (ACK) feedback in response to the detected triggering condition.

2. The method of claim 1, wherein the HARQ process is a dynamic HARQ ACK feedback process, and the method further comprises:
determining an overflow event as the triggering condition;
wherein the overflow event indicates that a number of groups of transport units are transmitted, the number of the groups of transport units reaches a maximum group identifier (ID) associated with the dynamic HARQ ACK feedback process, and a counter downlink assignment indicator (C-DAI) of the groups of transport units is incremented to a maximum C-DAI associated with the dynamic HARQ ACK feedback process.

3. The method of claim 2, wherein each of the transport units comprises one of a transport block (TB), a code block group (CBG), and a code block (CB).

4. The method of claim 1, further comprising determining a listen before talk (LBT) failure event as the triggering condition, wherein the LBT failure event indicates that LBT failure is detected.

5. The method of claim 1, further comprising determining a confliction event as the triggering condition, wherein the confliction event indicates that multiple versions of HARQ ACK bits for a transport unit are received, and a subsequently transmitted version among the versions of the HARQ ACK bits is inconsistent with a previous version among the versions of the HARQ ACK bits.

6. The method of claim 1, comprising determining an event of two misalignment onsets in a predetermined duration as the triggering condition.

7. The method of claim 5, further comprising:
receiving an updated version from the one-shot HARQ ACK feedback as the last version among the versions of the HARQ ACK bits; and
discarding the previous version and using the last version as a basis for data retransmission.

8. The method of claim 7, further comprising:
requesting retransmission of the one-shot HARQ ACK feedback when the last version is inconsistent with the versions of the HARQ ACK bits.

9. The method of claim 7, further comprising:
requesting retransmission of the one-shot HARQ ACK feedback when a proportion of bits in the last version is inconsistent with the versions of the HARQ ACK bits, and the proportion is greater than a threshold.

10. An apparatus for processing hybrid automatic repeat request (HARQ) feedback, comprising:
a transceiver configured to transceiving HARQ signaling;
a processor configured to execute method for processing HARQ feedback according to claim 1.

11. (canceled)

12. (canceled)

13. (canceled)

14. (canceled)

15. (canceled)

16. (canceled)

17. (canceled)

18. (canceled)

19. The apparatus of claim 10, wherein the apparatus comprises a gNB base station.

20. A method for processing hybrid automatic repeat request (HARQ) feedback, comprising:
triggering one-shot HARQ acknowledgement (ACK) feedback in response to the detected triggering condition;
obtaining multiple versions of HARQ ACK bits for a transport unit from the one-shot HARQ ACK feedback; and
consolidating the versions of HARQ ACK bits for the transport unit when a subsequently transmitted version among the versions of the HARQ ACK bits is inconsistent with a previous version among the versions of the HARQ ACK bits.

21. The method of claim 20, further comprising:
receiving an updated version from the one-shot HARQ ACK feedback as the last version among the versions of the HARQ ACK bits; and
discarding the previous version and using the last version as a basis for data retransmission.

22. The method of claim 21, further comprising:
requesting retransmission of the one-shot HARQ ACK feedback when the last version is inconsistent with the versions of the HARQ ACK bits.

23. The method of claim 21, further comprising:
requesting retransmission of the one-shot HARQ ACK feedback when a proportion of bits in the last version is inconsistent with the versions of the HARQ ACK bits, and the proportion is greater than a threshold.

24. The method of claim 20, wherein each of the transport units comprises one of a transport block (TB), a code block group (CBG), and a code block (CB).

25. An apparatus for processing hybrid automatic repeat request (HARQ) feedback, comprising:
a transceiver configured to transceiving HARQ signaling;
a processor configured to execute the method for processing HARQ feedback according to claim 20.

26. (canceled)

27. (canceled)

28. (canceled)

29. (canceled)

30. The apparatus of claim 25, wherein the apparatus comprises a gNB base station.
